(19) United States
(12) Patent Application Publication
(10) Pub. No.: US 2009/0162745 A1
(43) Pub. Date: Jun. 25, 2009

(54) ALKALINE BATTERY

(76) Inventors: Shinichi IWAMOTO, Osaka (JP); Yoshihisa HIROSE, Osaka (JP)

Correspondence Address: BIRCH STEWART KOLASCH & BIRCH, PO BOX 747, FALLS CHURCH, VA, 22040-0747, US

(21) Appl. No.: 12/338,415

(22) Filed: Dec. 18, 2008

(30) Foreign Application Priority Data
Dec. 19, 2007 (JP) 2007-326682

(51) Int. Cl. H01M 10/26; H01M 4/42; H01M 10/24; H01M 4/50; H01M 4/48; H01M 2/14; H01M 4/58

(52) U.S. Cl. 429/129; 429/229; 429/188; 429/224; 429/231

(57) ABSTRACT

An alkaline battery of the present invention includes a positive electrode, a negative electrode containing zinc particles or zinc alloy particles, and an alkaline electrolyte solution, wherein the ratio of the zinc particles or zinc alloy particles of the negative electrode capable of passing through a 200-mesh sieve is 10 to 80% by mass, and the ratio of a negative electrode capacity to a positive electrode capacity is 1.05 to 1.10. Furthermore, it is preferred that the ratio of the negative electrode capacity to the positive electrode capacity is 1.08 or less.

### BACKGROUND OF THE INVENTION

1. Field of the Invention

The present invention relates to an alkaline battery excellent in high rate characteristics, in which a gas generation amount during overdischarge is small.

2. Description of Related Art

In a conventional alkaline battery using zinc as a negative active material, the ratio of a negative electrode capacity to a positive electrode capacity (negative electrode capacity/positive electrode capacity) generally is set to be about 1.2 so that the negative electrode capacity is larger than the positive electrode capacity to some degree (for example, see JP 61 (1986)-54157 A). In a negative electrode of an alkaline battery a coating film of a zinc oxide with a high resistance is formed on the surface of zinc by a discharge reaction, so that the utilization ratio of zinc is relatively low, and the entire zinc may not be reacted efficiently. Therefore, the high rate characteristics and discharge capacity of a battery have been enhanced by setting a negative electrode capacity to be larger than a positive electrode capacity as described above.

However, when the negative electrode capacity is set to be larger as described above, unreacted zinc remains in a battery after the completion of the discharge of the battery, which causes a problem in that a gas generation amount during overdischarge increases. More specifically, if an alkaline battery with discharge completed is taken out from a working appliance early, no problems arise particularly; however, if such a battery is left in the working appliance, the battery is overdischarged and gas is generated therein, resulting in the leakage of an alkaline electrolyte solution. Therefore, in order to avoid such a problem of the leakage of an electrolyte solution, it is required to reduce the gas generation amount in an alkaline battery during overdischarge.

For the purpose of solving the problem of gas generation during overdischarge in an alkaline battery as described above, for example, a technique of reducing the amount of an electrolyte solution (JP 7 (1995)-122276 A) and a technique of optimizing the ratio between a positive electrode capacity and a negative electrode capacity (JP 11 (1999)-40173 A) have been proposed.

However, even with the above-mentioned techniques, high rate characteristics still cannot be enhanced sufficiently while the gas generation during overdischarge of an alkaline battery is suppressed.

### SUMMARY OF THE INVENTION

Therefore, with the foregoing in mind, it is an object of the present invention to provide an alkaline battery including a positive electrode, a negative electrode containing zinc particles or zinc alloy particles, and an alkaline electrolyte solution (hereinafter, which may be referred to merely as an “electrolyte solution”), wherein the ratio of the zinc particles or zinc alloy particles of the negative electrode, which are capable of passing through a 200-mesh sieve, is 10 to 80% by mass, and the ratio of the negative electrode capacity to the positive electrode capacity is 1.05 to 1.10.

According to the present invention, an alkaline battery excellent in high rate characteristics, in which a gas generation amount during overdischarge is small, can be provided. The alkaline battery of the present invention can suppress the leakage of an electrolyte solution during overdischarge.

### BRIEF DESCRIPTION OF THE DRAWINGS

FIG. 1 is a cross-sectional view showing an example of an alkaline battery of the present invention.

FIG. 2 is a cross-sectional view showing another example of the alkaline battery of the present invention.

### DETAILED DESCRIPTION OF THE INVENTION

Hereinafter, the configuration of an alkaline battery of the present invention will be described in detail.

### <Negative Electrode>

A negative electrode in an alkaline battery of the present invention is formed of a gel negative electrode mixture containing zinc particles or zinc alloy particles (hereinafter, both of which will be referred to as “zinc-based particles” collectively), an electrolyte solution, and a gelling agent. A zinc component in the zinc-based particles functions as a negative active material.

From the viewpoint of suppressing the gas generation caused by the reaction between the negative active material and the electrolyte solution, it is preferred that the zinc-based particles are zinc alloy particles containing elements of indium, bismuth, aluminum or the like as alloy components. Regarding the contents of these elements in the zinc alloy particles, for example, the content of indium is preferably 0.02 to 0.07% by mass, the content of bismuth is preferably 0.007 to 0.025% by mass, and the content of aluminum is preferably 0.001 to 0.004% by mass. The zinc alloy particles may contain only one kind of the alloy component or at least two kinds of the alloy components. The other components of the zinc alloy particles are, for example, zinc and inevitable impurities.

Regarding the zinc-based particles used in the negative electrode, the ratio of those which are capable of passing through a 200-mesh sieve is 10% by mass or more. Herein, the mesh refers to the unit of a particle size stipulated under Japanese Industrial Standards (JIS) Z 8801, which is expressed by the number of meshes included in one square inch. When the zinc-based particles used in the negative electrode are fine as such, the specific surface area of the entire zinc-based particles becomes large, and the reaction at the negative electrode can be effected efficiently, so that satisfactory high rate characteristics of the battery are obtained. This also decreases the distance from the surface of the zinc-based particles to the center thereof, so that the utilization ratio of zinc is enhanced even during discharge with relatively low rate characteristics (light-load discharge). Therefore, as described later, the ratio of a negative electrode capacity to a positive electrode capacity can be made lower than that of a conventional example, and the amount of unreacted zinc (amount of zinc components in the zinc-based particles) is decreased at the completion of discharge, whereby the gas generation during overdischarge can be suppressed. It is preferred that the ratio of the zinc-based particles that are capable of passing through a 200-mesh sieve is 20% by mass or more.

Furthermore, as the ratio of the zinc-based particles that are capable of passing through a 200-mesh sieve increases, the specific surface area of the entire zinc-based particles increases. This further increases the reactivity between the zinc-based particles and the electrolyte solution; consequently, the amount of the electrolyte solution to be consumed during a discharge reaction increases too much and the electrolyte solution may tend to become insufficient. When the electrolyte solution tends to become insufficient, the utilization ratio of the zinc-based particles as an active material decreases, which makes it difficult to enhance the discharge characteristics of the battery. Furthermore, when the ratio of fine particles occupying the zinc-based particles increases, the entire zinc-based particles increase in volume, which makes it difficult to handle the zinc-based particles in the course of production of a battery. Thus, in the battery of the present invention, from the viewpoint of enhancing the discharge characteristics while suppressing the occurrence of the above-mentioned phenomenon in which the electrolyte solution tends to become insufficient, and improving the handleability of the zinc-based particles in the course of production of a battery, it is preferred that the ratio of the zinc-based particles that are capable of passing through a 200-mesh sieve is 80% by mass or less, and preferably 40% by mass or less.

Furthermore, by using the zinc-based particles containing those which are capable of passing through a 200-mesh sieve, at a ratio of the above-mentioned predetermined value, the gas generation amount involved in the corrosion caused by the reaction with the electrolyte solution can be decreased even during the storage of an alkaline battery, and a homogeneous negative electrode mixture with satisfactory flowability also can be prepared.

Considering the handleability in the course of production of a battery, it is desired that the zinc-based particles of the negative electrode have a minimum particle size of about 7 μm. It also is preferred that all the zinc-based particles are capable of passing through an 80-mesh sieve.

As an electrolyte solution used in the negative electrode, for example, an alkaline aqueous solution obtained by dissolving a hydroxide of alkali metal such as potassium hydroxide, sodium hydroxide or lithium hydroxide in water, or an alkaline aqueous solution with zinc oxide or the like added thereto can be used. As described later, from the viewpoint of enhancing the safety of a battery, a potassium hydroxide aqueous solution is more preferred. Regarding the concentration of a hydroxide of alkali metal in an electrolyte solution, for example, in the case where an electrolyte solution is a potassium hydroxide aqueous solution, the concentration of potassium hydroxide is preferably 28 to 38% by mass. Furthermore, in the case where zinc oxide is added to the electrolyte solution, the concentration of zinc oxide is preferably 1.0 to 4.0% by mass.

Examples of the gelling agent used in the negative electrode include polyacrylic acids such as polyacrylic acid, sodium polyacrylate, and ammonium polyacrylate; celluloses such as carboxymethyl cellulose (CMC), methyl cellulose, hydroxypropyl cellulose; and alkali salts thereof. Furthermore, as disclosed by JP 2001-307746 A, it also is preferred that a cross-linked polyacrylic acid or a salt type water-absorbing polymer (e.g., sodium polyacrylate, ammonium polyacrylate, etc.) is used together with another gelling agent. Examples of the gelling agent to be used with the cross-linked polyacrylic acid or salt-type water-absorbing polymer thereof include the above-mentioned celluloses, a cross-linked branch type polyacrylic acid, and salts thereof (e.g., a sodium salt, an ammonium salt, etc.). It is desired that the above-mentioned cross-linked polyacrylic acid or salt-type water-absorbing polymer thereof has an average particle size of 10 to 100 μm and has a spherical shape.

It is preferred that the content of the zinc-based particles in a negative electrode mixture is, for example, 50 to 75% by mass. Furthermore, it is preferred that the content of an electrolyte solution in the negative electrode mixture is, for example, 25 to 50% by mass. Furthermore, it is preferred that the content of the gelling agent in the negative electrode mixture is, for example, 0.01 to 1.0% by mass.

Furthermore, the negative electrode mixture also can contain a small amount of an indium compound such as indium oxide and a bismuth compound such as bismuth oxide. By allowing the negative electrode mixture to contain these compounds, the gas generation caused by the corrosion reaction between the zinc-based particles and the electrolyte solution can be prevented more effectively. When these compounds are contained too much in the negative electrode mixture, they may decrease the high rate characteristics of a battery, so that it is preferred to determine the content as required in a range not causing such a problem. For example, it is recommended that the negative electrode mixture contains about 0.003 to 0.05 parts by mass of the indium compound and about 0.003 to 0.05 parts by mass of the bismuth compound with respect to 100 parts by mass of the zinc-based particles.

### <Positive Electrode>

A positive electrode of the alkaline battery of the present invention is formed, for example, by mixing manganese dioxide or nickel oxyhydroxide that is an active material, a conductive assistant, and further an electrolyte solution and a binder for forming to obtain a positive electrode mixture, and forming the positive electrode mixture into a ring shape or the like under pressure.

It is preferred that the positive active material has a BET specific surface area of 40 m²/g to 100 m²/g. When the BET specific surface area of the positive active material is too small, a reaction efficiency is degraded due to the decrease in a reaction area although formability is satisfactory, with the result that the effect of enhancing high rate characteristics may be decreased. Furthermore, when the BET specific surface area of the positive active material is too large, the formability may be degraded due to the decrease in a volume density although the reaction efficiency is enhanced. In order to enhance the strength of a positive electrode mixture compact by enhancing the formability of the positive active material, the BET specific surface area of the positive active material is more preferably 45 m²/g to 60 m²/g.

The BET specific surface area of the positive active material as used herein refers to a specific surface area of the surface of the active material and fine pores, obtained by measuring and calculating a surface area, using a BET expression that is a theoretical expression of multilayer adsorption. Specifically, the BET specific surface area is a value obtained using a specific surface area measurement apparatus (“Macsorb HIM modele-1201” manufactured by Mountech Co. Ltd.) by a nitrogen adsorption method.

Furthermore, in the case of using manganese dioxide as a positive active material, it is desired that manganese dioxide contains 0.01 to 3.0% by mass of titanium. In manganese dioxide containing titanium in an amount to this degree, the reaction efficiency is enhanced due to the increase in a specific surface area, so that the high rate characteristics of an alkaline battery further can be enhanced.

As the conductive assistant used in the positive electrode, for example, graphite, Ketjen black, acetylene black, or the like can be used. It is preferred that the content of the conductive assistant in the positive electrode mixture is set to be, for example, 3 to 8.5 parts by mass with respect to 100 parts by mass of the positive active material.

As the binder used in the positive electrode, for example, polytetrafluoroethylene, polyvinylidene fluoride, styrenebutadiene rubber, or the like can be used. It is preferred that the content of the binder in the positive electrode mixture is set to be, for example, 0.1 to 1% by mass.

As the electrolyte solution used in the positive electrode, for example, an alkaline aqueous solution obtained by dissolving a hydroxide of alkali metal such as potassium hydroxide, sodium hydroxide or lithium hydroxide in water, or an alkaline aqueous solution with zinc oxide or the like added thereto can be used. As described later, from the viewpoint of enhancing the safety of a battery, a potassium hydroxide aqueous solution is more preferred. Regarding the concentration of a hydroxide of alkali metal in the electrolyte solution, for example, in the case where the electrolyte solution is a potassium hydroxide aqueous solution, the concentration of potassium hydroxide is preferably 40 to 60% by mass. Furthermore, in the case where zinc oxide is added to the electrolyte solution, the concentration of zinc oxide is preferably 10 to 4.0% by mass.

### <Ratio of a Negative Electrode Capacity to a Positive Electrode Capacity>

As described above, the gas generation in a battery during overdischarge occurs when unreacted zinc (zinc components in zinc-based particles) not participated in the discharge reaction is present at the negative electrode after the completion of the discharge of a battery. Thus, in the battery of the present invention, the ratio of a negative electrode capacity to a positive electrode capacity (negative electrode capacity/positive electrode capacity) is 1.10 or less, and preferably 1.08 or less. By using a negative electrode having the zinc-based particles in the above form while decreasing the ratio of the negative electrode capacity to the positive electrode capacity to reduce the amount of unreacted zinc at the completion of discharge as soon as possible, and suppressing the gas generation during overdischarge, the high rate characteristics also are enhanced.

When the ratio of the negative electrode capacity to the positive electrode capacity is too small, the balance between the positive electrode capacity and the negative electrode capacity is degraded to decrease the discharge capacity of a battery. Therefore, in the battery of the present invention, the ratio of the negative electrode capacity to the positive electrode capacity is 1.05 or more and more preferably 1.06 or more.

The ratio of the negative electrode capacity to the positive electrode capacity in the battery of the present invention is a value obtained as follows. The content of the positive active material manganese dioxide or nickel oxyhydroxide) after the assembly of a battery is calculated from the mass thereof and analyzed values of the content by percentage of manganese (Mn) and the content by percentage of nickel (Ni) therein, and the content of the negative active material (zinc (Zn) components in the zinc-based particles) is calculated by collecting the gel negative electrode mixture, washing the mixture with water, and analyzing the content by percentage of Zn. The content by percentage of Mn and the content by percentage of Ni in the positive active material, and the content by percentage of Zn in the negative active material are obtained by an inductively coupled plasma (ICP) analysis. Then, the positive electrode capacity is calculated from the content of the positive active material (the amount of manganese dioxide and the amount of nickel oxyhydroxide), setting the capacity of manganese dioxide to be 308 mAh/g and the capacity of nickel oxyhydroxide to be 292 mAh/g, and the negative electrode capacity is calculated from the content of the negative active material (the amount of Zn), setting the capacity of zinc to be 820 mAh/g, whereby the ratio of the negative electrode capacity to the positive electrode capacity is obtained.

As the capacities of zinc, manganese dioxide (MnO₂), and nickel oxyhydroxide (NiOOH), numerical values are used, which are obtained by taking reciprocals of masses (1.220, 3.244, and 3.422) per unit quantity of electricity of Zn, MnO₂, and NiOOH in Table 1•4•1 “Mass and volume per unit quantity of electricity of various battery active materials” described on page 27 of “Battery Guidebook 3rd Edition (Maruzen Co., Ltd.)”, and adjusting the units.

### <Alkaline Electrolyte Solution>

As described above, the positive electrode mixture constituting the positive electrode and the negative electrode mixture constituting the negative electrode respectively contain alkaline electrolyte solutions. However, by only using these alkaline electrolyte solutions, there may arise a problem in that the amounts of the electrolyte solutions become insufficient to decrease the performance of a battery, and the like. Therefore, it is necessary to further inject an electrolyte solution in the battery.

As the electrolyte solution to be injected in the battery, other than those used in the positive electrode and the negative electrode, in the same way as in the electrolyte solution of the positive electrode or the negative electrode, for example, an alkaline aqueous solution made of an aqueous solution of a hydroxide of alkali metal such as potassium hydroxide, sodium hydroxide or lithium hydroxide, or an alkaline aqueous solution with zinc oxide or the like added thereto can be used. Regarding the concentration of a hydroxide of alkali metal in an electrolyte solution, for example, when the electrolyte solution is a potassium hydroxide aqueous solution, the concentration of potassium hydroxide is preferably 28 to 38% by mass, and when zinc oxide is added to the electrolyte solution, the concentration thereof is preferably 1.0 to 4.0% by mass.

From the viewpoint of enhancing the safety of a battery, it is desired that a potassium hydroxide aqueous solution is used in any of an electrolyte solution for a positive electrode, an electrolyte solution for a negative electrode, and an electrolyte solution to be injected in the battery (hereinafter, these solutions will be referred to as an alkaline electrolyte solution in a battery collectively), and the concentration of each of the electrolyte solutions is adjusted so that the concentration of potassium hydroxide in the electrolyte solution in the battery becomes preferably 38% by mass or less, and more preferably 35% by mass or less on average, using a potassium hydroxide aqueous solution.

It is conjectured that when the concentration of potassium hydroxide in the alkaline electrolyte solution in the battery is high, the ion conductivity of the electrolyte solution is low, and when the electrolyte solution is used together with the negative electrode having zinc-based particles in a fine form as described above, the electric resistance of a discharge product formed on the surface of the zinc-based particles is high. Therefore, there is a possibility that the temperature becomes too high at a time of shortings of the battery, and the safety may be impaired, and the utilization ratio of the zinc components in the zinc-based particles tends to decrease, which increases the amount of unreacted zinc components at a time of the completion of discharge.

If the average value of the concentration of potassium hydroxide in the alkaline electrolyte solution in the battery is set to be low as described above, the electric resistance of the electrolyte solution is lowered, and a discharge product with a low resistance can be generated on the surface of the zinc-based particles, and the increase in temperature at a time of shortings of the battery can be suppressed to enhance the safety. Furthermore, the utilization ratio of the zinc components in the zinc-based particles is enhanced further, whereby the amount of unreacted zinc components at a time of the completion of discharge can be reduced further.

If the concentration of potassium hydroxide in an electrolyte solution is decreased too much, the ion conductivity of the electrolyte solution tends to decrease on the contrary. Therefore, it is desired that the concentration of each potassium hydroxide of the electrolyte solution for a positive electrode, the electrolyte solution for a negative electrode, and the electrolyte solution to be injected in the battery are adjusted so that the concentration of potassium hydroxide in the electrolyte solution in the battery becomes preferably 28% by mass or more, and more preferably 30% by mass or more on average.

### <Separator>

There is no particular limit to a separator of the alkaline battery of the present invention, and for example, a non-woven fabric containing vinylon and rayon as main components, a vinylon•rayon non-woven fabric (vinylon•rayon mixed paper), a polyamide non-woven fabric, a polyolefin•rayon non-woven fabric, vinylon paper, vinylon•linter wood paper, vinylon mercerized wood paper, or the like can be used. Alternatively, a separator obtained by laminating a microporous polyolefin film (a microporous polyethylene film, a microporous polypropylene film, etc.) subjected to a hydrophilic treatment, a cellophane film, and a liquid-absorbing layer such as vinylon•rayon mixed paper may be used.

### <Configuration of an Alkaline Battery, and Other Constituent Elements>

Although there is no particular limit to the shape of the alkaline battery of the present invention, examples of the shape include tube shapes (a cylinder shape, a rectangular tube shape, etc.).

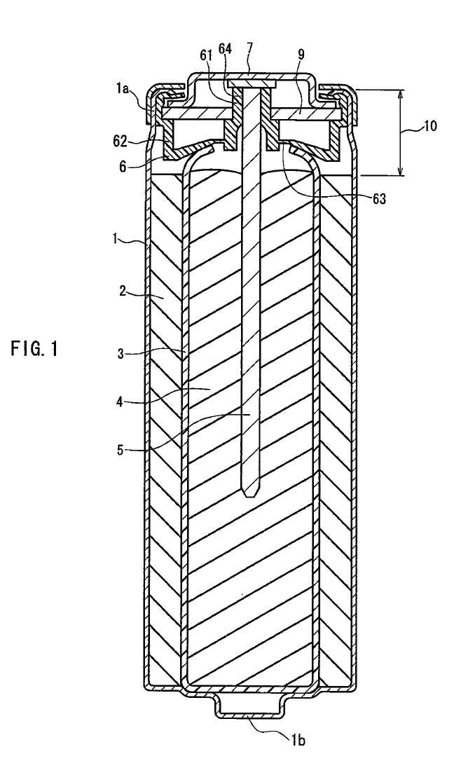

Hereinafter, the configuration of a battery of the present invention will be described with reference to the drawings. FIG. 1 is a cross-sectional view showing an example of an alkaline battery of the present invention. In the alkaline battery shown in FIG. 1, a positive electrode 2 (positive electrode mixture compact) formed in a ring shape is placed in a metallic exterior can 1 (made of iron plated with Ni, stainless steel, etc.) in a bottomed cylinder shape (cup shape), a cup-shaped separator 3 is placed on an inner side of the positive electrode 2, and an alkaline electrolyte solution (not shown) has been injected from the inner side of the separator 3. Furthermore, the inner side of the separator 3 is filled with a negative electrode 4 (gel negative electrode mixture) containing zinc-based particles. Reference numeral 1b in the exterior can 1 denotes a positive electrode terminal. An opening end 1a of the exterior can 1 is provided with a metallic negative electrode terminal plate 7 (made of iron plated with Ni, stainless steel, etc.), and the opening end 1a is bent inwardly to be sealed via an outer peripheral portion 62 of a sealing body 6 made of a resin. A metallic negative collecting rod 5 (made of brass plated with tin (Sn), etc.) is welded to the negative electrode terminal plate 7 at a head portion, and the negative electrode collecting rod 5 is inserted in the negative electrode 4 through a transmission hole 64 provided at a center portion 61 of the sealing body 6. As support means for preventing the deformation of the negative electrode terminal plate 7 at a time of sealing and supporting the sealing body 6 from the inner side, a metal washer 9 (disk-shaped metal plate) is placed. A thin portion 63 for explosion proofing is formed at the sealing body 6 made of a resin. In the case where gas is generated in the battery at a time of shortings, the thin portion 63 of the sealing body 6 is cleaved first, and the gas moves to the metal washer 9 through the generated cleaved hole. The metal washer 9 and the negative electrode terminal plate 7 are provided with gas-draining holes (not shown), and the gas in the battery is discharged outside of the battery through the gas-draining holes. As the resin constituting the sealing body 6 made of a resin, for example, there are nylon 66, and the like.

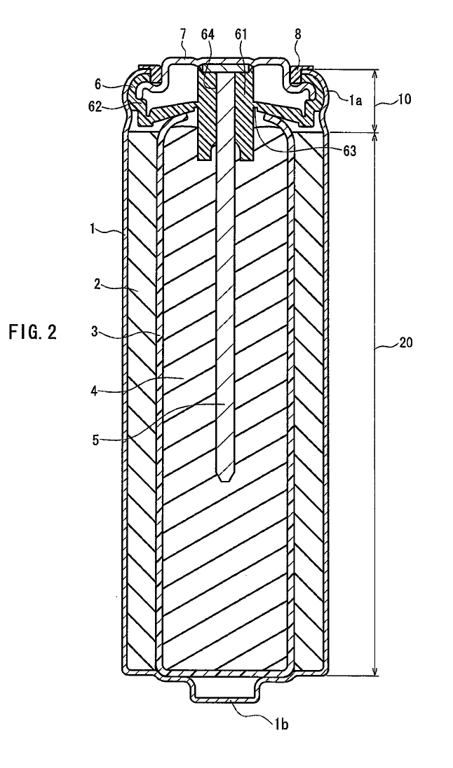

FIG. 2 is a cross-sectional view showing another example of the alkaline battery of the present invention. In FIG. 2, elements having the same functions as those in FIG. 1 are denoted with the same reference numerals as those therein, and repeated descriptions will be omitted. In FIG. 2, reference numeral 8 denotes an insulating plate for insulating the negative electrode terminal plate 7 from the exterior can 1. Reference numeral 20 denotes a body portion containing an electric-power generating element.

In the alkaline battery shown in FIG. 1, since the metal washer 9 is used, the volume occupied by a sealed portion (reference numeral 10 in FIG. 1) becomes large. In contrast, by eliminating the metal washer 9 as in the battery shown in FIG. 2, and using the negative electrode terminal plate 7 as the support means for supporting the sealing body 6 from the inner side, the volume occupied by the sealed portion 10 is reduced to increase the volume of the body portion 20 capable of containing the electric-power generating element, and the filling amount of each mixture of the positive electrode 2 and the negative electrode 4 can be increased, compared with that in the battery shown in FIG. 1.

The alkaline battery of the present invention can be applied to the same various uses as those for which conventionally known alkaline batteries are used.

Hereinafter, the present invention will be described in detail by way of examples. The following examples will not limit the present invention.

### EXAMPLE 1

Manganese dioxide, graphite, polytetrafluoroethylene powder, and an alkaline electrolyte solution for preparing a positive electrode mixture (56% by mass of a potassium hydroxide aqueous solution containing 2.9% by mass of zinc oxide) were mixed in a mass ratio of 88.2:5.8:0.2:5.7 to prepare a positive electrode mixture. In the positive electrode mixture, the amount of graphite was 6.7 parts by mass with respect to 100 parts by mass of manganese dioxide.

Next, zinc alloy particles containing indium (In), bismuth (Bi), and aluminum (Al) in a ratio of 0.05% by mass, 0.015% by mass, and 0.005% by mass respectively, sodium polyacrylate, polyacrylic acid, and an alkaline electrolyte solution for preparing a negative electrode mixture (30% by mass of a potassium hydroxide aqueous solution containing 3.0% by mass of zinc oxide) were mixed in a mass ratio of 39:0.2:0.2:20 to prepare a gel negative electrode mixture. The zinc alloy particles had an average particle size of 135 μm and all passed through a 35-mesh sieve, and the amount of the zinc alloy particles passing through a 200-mesh sieve was 20% by mass with respect to the total amount of the zinc alloy particles, and the volume density thereof was 2.9 g/cm³.

Furthermore, as the exterior can, the exterior can 1 for an AAA alkaline battery in the shape shown in FIG. 2, made of a killed steel plate with matte Ni plated on the surface, was prepared. The exterior can 1 is formed in such a manner that the thickness of the sealed portion 10 is 0.20 mm, and the thickness of the body portion 20 is 0.20 mm. Furthermore, in order to prevent dents from being formed on the positive electrode terminal 1b when the battery is dropped, the can thickness at the positive electrode terminal portion is set to be slightly larger than that of the body portion 20. An alkaline battery was produced using the exterior can 1 as follows.

About 4.85 g of the positive electrode mixture was inserted in the exterior can 1 to form a bobbin shape (hollow cylinder shape), whereby four positive electrode mixture compacts (density: 3.36 g/cm³) with an inner diameter of 6.6 mm, an outer diameter of 9.7 mm, and a height of 9.0 mm were laminated. Next, a groove was formed at a position of 3.5 mm in a height direction from the opening end of the exterior can 1, and a pitch was applied to the inner side of the exterior can 1 up to the groove position so as to enhance the contact between the exterior can 1 and the sealing body 6.

Next, a non-woven fabric made of acetalized vinylon and tinsel having a thickness of 100 μm and a mass per unit area of 30 g/m² was rolled to a tube shape in three layers, a portion to be a bottom was bent and heat-sealed, whereby a cup-shaped separator 3 whose one end was closed was obtained. The separator 3 was placed on the inner side of the positive electrode 2 (positive electrode mixture compact) inserted in the exterior can 1, 0.65 g of an alkaline electrolyte solution (potassium hydroxide aqueous solution having a concentration of 30% by mass containing 3.0% by mass of zinc oxide) for injection was injected into the inner side of the separator 3, and further, the inner side of the separator 3 was filled with 2.45 g of the negative electrode mixture to obtain a negative electrode 4. Herein, the ratio of the negative electrode capacity to the positive electrode capacity was 1.10.

After the filling of the electric-power generating element, the negative electrode collecting rod 5 made of brass with tin plated on the surface and combined with the sealing body 6 made of Nylon 66 was inserted into the center portion of the negative electrode 4, and the opening end 1a of the exterior can 1 was crimped from above with a die, whereby an AAA alkaline battery shown in FIG. 2 was produced. Herein, as the negative electrode collecting rod 5, the negative electrode collecting rod was used, which was previously welded to the negative electrode terminal plate 7 made of a nickel-plated steel plate with a thickness of 0.4 mm formed by punching and pressing. As described above, a tube-shaped alkaline battery of Example 1 was produced.

### EXAMPLE 2

A tube-shaped alkaline battery was produced in the same way as in Example 1, except that the filling amount of a negative electrode mixture was changed to 2.38 g. In the tube-shaped alkaline battery, the ratio of the negative electrode capacity to the positive electrode capacity was 1.07.

### EXAMPLE 3

A tube-shaped alkaline battery was produced in the same way as in Example 1, except that the filling amount of the negative electrode mixture was changed to 2.36 g. In the tube-shaped alkaline battery, the ratio of the negative electrode capacity to the positive electrode capacity was 1.06.

### COMPARATIVE EXAMPLE 1

A tube-shaped alkaline battery was produced in the same way as in Example 1, except that the filling amount of the negative electrode mixture was changed to 2.55 g. In the tube-shaped alkaline battery, the ratio of the negative electrode capacity to the positive electrode capacity was 1.15.

### COMPARATIVE EXAMPLE 2

A tube-shaped alkaline battery was produced in the same way as in Example 1, except that the filling amount of the negative electrode mixture was changed to 2.50 g. In the tube-shaped alkaline battery, the ratio of the negative electrode capacity to the positive electrode capacity was 1.12.

### COMPARATIVE EXAMPLE 3

A tube-shaped alkaline battery was produced in the same way as in Example 1, except that the filling amount of the negative electrode mixture was changed to 2.31 g. In the tube-shaped alkaline battery, the ratio of the negative electrode capacity to the positive electrode capacity was 1.04.

In the tube-shaped alkaline batteries in Examples 1-3 and Comparative Examples 1-3, a discharge characteristics confirming test and an overdischarge test were conducted as follows. Table 1 shows these results together with the ratio between the positive and negative electrode capacities.

### <Discharge Characteristics Confirming Test>

The tube-shaped alkaline batteries in Examples 1-3 and Comparative Examples 1-3 were discharged continuously at 20° C. and 750 mW under the condition of a termination voltage of 1.0 V, and discharge capacities were calculated from a discharge time taken until the termination voltage was reached. Table 1 shows the results. Table 1 shows relative values assuming that the results in the battery in Example 1 were set to be 100.

### <Overdischarge Test>

The tube-shaped alkaline batteries (batteries different from those subjected to the above-mentioned discharge characteristics confirming test) in Examples 1-3 and Comparative Examples 1-3 were overdischarged by being discharged at 20° C. and 20° C. for 48 hours, and thereafter, the pressure in each battery after being retained at 20° C. for 120 hours was measured. For measurement of the pressure in each of the batteries, 5 batteries each in Examples 1-3, and 5 batteries each in Comparative Examples 1-3 were used, and Table 1 shows an average value of these results.

TABLE 1

| | Negative electrode | | Battery internal pressure |
|---|---|---|---|
| | capacity/positive | Discharge capacity during | after overdischarge test |
| | electrode capacity | continuous discharge at 750 mW | (MPa) |
| Example 1 | 1.10 | 100 | 1.55 |
| Example 2 | 1.07 | 94 | 1.45 |
| Example 3 | 1.06 | 94 | 1.43 |
| Comparative | 1.15 | 106 | 2.12 |
| Example 1 | | | |
| Comparative | 1.12 | 103 | 1.74 |
| Example 2 | | | |
| Comparative | 1.04 | 76 | 1.38 |
| Example 3 | | | |

As is apparent from Table 1, in the tube-shaped alkaline batteries in Examples 1-3, the increase in a battery internal pressure during overdischarge is small, which means that the gas generation amount in the battery caused by overdischarge is small. Thus, in the tube-shaped alkaline batteries in Examples 1-3, the gas generation during overdischarge is suppressed, whereby the leakage of an electrolyte solution by the operation of a vent can be prevented. In contrast, in the tube-shaped alkaline batteries in Comparative Examples 1-2 having a high ratio between the positive and negative electrode capacities, a large amount of unreacted zinc not participated in discharge remains in the battery, so that the gas amounts during overdischarge are larger than those in the batteries in Examples 1-3, and an electrolyte solution may leak during overdischarge.

The discharge capacities of the batteries in Examples 1-3 are the same as those of the batteries in Comparative Examples 1 and 2, and in the battery in Comparative Example 3 having a small negative electrode capacity, the capacity balance between the positive electrode and the negative electrode in the battery is lost, so that the discharge capacity is considered to be decreased substantially.

The invention may be embodied in other forms without departing from the spirit or essential characteristics thereof. The embodiments disclosed in this application are to be considered in all respects as illustrative and not limiting. The scope of the invention is indicated by the appended claims rather than by the foregoing description, and all changes which come within the meaning and range of equivalency of the claims are intended to be embraced therein.

What is claimed is:

1. An alkaline battery comprising: a positive electrode; a negative electrode containing zinc particles or zinc alloy particles; and an alkaline electrolyte solution,
wherein a ratio of the zinc particles or the zinc alloy particles of the negative electrode, capable of passing through a 200-mesh sieve, is 10 to 80% by mass, and
a ratio of a negative electrode capacity to a positive electrode capacity is 1.05 to 1.10.

2. The alkaline battery according to claim 1, wherein the ratio of the negative electrode capacity to the positive electrode capacity is 1.08 or less.

3. The alkaline battery according to claim 1, wherein an alkaline electrolyte solution in a battery is 28 to 38% by mass on average of a potassium hydroxide aqueous solution.

4. The alkaline battery according to claim 1, wherein the zinc alloy particles contain at least one element selected from indium, bismuth, and aluminum as an alloy component.

5. The alkaline battery according to claim 1, wherein a minimum particle size of the zinc particles or zinc alloy particles of the negative electrode is 7 μm.

6. The alkaline battery according to claim 1, wherein all the zinc particles or zinc alloy particles of the negative electrode are capable of passing through a 80-mesh sieve.

7. The alkaline battery according to claim 1, wherein the alkaline electrolyte solution used in the negative electrode is 28 to 38% by mass of a potassium hydroxide aqueous solution.

8. The alkaline battery according claim 1, wherein the alkaline electrolyte solution used in the negative electrode contains 1.0 to 4.0% by mass of zinc oxide.

9. The alkaline battery according to claim 1, wherein a negative electrode mixture constituting the negative electrode contains an indium compound or a bismuth compound.

10. The alkaline battery according to claim 1, wherein a positive active material contained in the positive electrode has a BET specific surface area of 40 m²/g to 100 m²/g.

11. The alkaline battery according to claim 1, wherein a positive active material contained in the positive electrode is manganese dioxide containing 0.01 to 3.0% by mass of titanium.

12. The alkaline battery according to claim 1, wherein an alkaline electrolyte solution used in the positive electrode is 40 to 60% by mass of a potassium hydroxide aqueous solution.

13. The alkaline battery according to claim 1, wherein an alkaline electrolyte solution used in the positive electrode contains 1.0 to 4.0% by mass of zinc oxide.

14. The alkaline battery according to claim 1, wherein an alkaline electrolyte solution to be injected in the battery is 28 to 38% by mass of a potassium hydroxide aqueous solution.

15. The alkaline battery according to claim 1, wherein an alkaline electrolyte solution to be injected in the battery contains 1.0 to 4.0% by mass of zinc oxide.

16. The alkaline battery according to claim 1, wherein a ring-shaped positive electrode mixture constituting the positive electrode is placed in a metallic exterior can in a bottomed cylinder shape,
the separator in a bottomed cylinder shape is placed on an inner side of the positive electrode mixture,
a gel negative electrode mixture constituting the negative electrode is placed on an inner side of the separator, and
an opening of the metallic exterior can is sealed with a sealing body.
